(19) United States
(12) Patent Application Publication
(10) Pub. No.: US 2026/0339364 A1
(43) Pub. Date: Oct. 29, 2026

(54) FLOW RATE CONTROL DEVICE AND OPERATING METHOD THEREOF

(71) Applicant: SAMSUNG ELECTRONICS CO., LTD., Suwon-si (KR)

(72) Inventors: Bong Ju LEE, Suwon-si (KR); Hyun Woong Kang, Suwon-si (KR); Doo Hyun Kwon, Suwon-si (KR); Ki-Jun Kim, Suwon-si (KR); Hyun Soo Kim, Suwon-si (KR); Dong Hoon Park, Suwon-si (KR); Tae-Joon Uem, Suwon-si (KR); Hae Sung Lee, Suwon-si (KR)

(73) Assignee: SAMSUNG ELECTRONICS CO., LTD., Suwon-si (KR)

(21) Appl. No.: 19/415,052

(22) Filed: Dec. 10, 2025

(30) Foreign Application Priority Data
Apr. 25, 2025 (KR) 10-2025-0054717

(51) Int. Cl. G05D 7/06; B24B 57/02

(52) U.S. Cl. CPC G05D 7/0635; B24B 57/02

(57) ABSTRACT

A flow rate control device includes an input terminal that receives, from a chamber that processes a substrate, a target flow rate of a fluid used for processing the substrate, from a flow controller, a current flow rate of the fluid that is supplied to the chamber, and a motor control signal for controlling a flow rate of the fluid provided to the chamber, a flow modulation module which modulates the target flow rate and the current flow rate so that the fluid is provided to the chamber at the target flow rate within a target reaction time, and an output terminal which provides the modulated target flow rate and the modulated current flow rate to the flow controller.

### CROSS-REFERENCE TO RELATED APPLICATION

This application claims priority from Korean Patent Application No. 10-2025-0054717 filed on Apr. 25, 2025 in the Korean Intellectual Property Office, the contents of which being herein incorporated by reference in its entirety.

### BACKGROUND

The present disclosure relates to a flow rate control device and an operating method of the flow rate control device.

In a chemical mechanical polishing (CMP) process during a semiconductor fabricating process, a slurry solution is provided to a chamber for processing a semiconductor device. However, a delay may occur until a target flow rate is reached due to fluidity of the slurry solution and various feedback control characteristics. Therefore, a flow rate control device in which such a delay is minimized may be advantageous.

### SUMMARY

It is an aspect to provide a flow rate control device with an improved reaction speed to a change in flow rate.

It is another aspect to provide an operating method of the flow rate control device with an improved reaction speed to a change in flow rate.

According to an aspect of one or more embodiments, there is provided a flow rate control device comprising an input terminal that is configured to receive from a chamber that processes a substrate, a target flow rate of a fluid used for processing the substrate, from a flow controller, a current flow rate of the fluid that is supplied to the chamber, and a motor control signal for controlling a flow rate of the fluid provided to the chamber; a flow modulation module which modulates the target flow rate and the current flow rate so that the fluid is provided to the chamber at the target flow rate within a target reaction time; and an output terminal which provides the modulated target flow rate and the modulated current flow rate to the flow controller.

According to another aspect of one or more embodiments, there is provided a method for operating a flow rate control device, the method comprising receiving a target flow rate of a fluid used to process a substrate, from a chamber for processing the substrate; receiving, from a flow controller, a current flow rate of fluid supplied to the chamber and a motor control signal for controlling a flow rate of fluid provided to the chamber; modulating the target flow rate and the current flow rate such that the fluid is provided to the chamber at the target flow rate within a target reaction time; and providing the flow controller with the modulated target flow rate and the modulated current flow rate.

According to yet another aspect of one or more embodiments, there is provided a flow rate control device comprising a flow meter which measures a flow rate of a fluid flowing through a flow tube that provides the fluid to a chamber for processing a substrate; a pinch valve which adjusts the flow rate of the fluid provided to the chamber; and a flow modulation module which receives a target flow rate of the fluid used for processing the substrate, from the chamber, receives, from the flow meter, a current flow rate of the fluid provided to the chamber, and generates a pinch valve control signal for controlling a position of the pinch valve such that the fluid is provided to the chamber at the target flow rate within a target reaction time. The flow modulation module is provided with a first target flow rate smaller than a second target flow rate from the chamber, provides the pinch valve with a first pinch valve control signal for controlling the pinch valve to be positioned at a first position, and provides the pinch valve with a second pinch valve control signal for controlling the pinch valve to be positioned at a second position, in response to the position of the pinch valve reaching the first position. The first position of the pinch valve causes a convergent flow rate of the fluid provided to the chamber to be the second target flow rate, and the second position of the pinch valve causes the convergent flow rate of the fluid provided to the chamber to be the first target flow rate.

### BRIEF DESCRIPTION OF THE DRAWINGS

The above and other aspects will become more apparent by describing in detail exemplary embodiments thereof with reference to the attached drawings, in which:

FIG. 1 is a block diagram showing a flow rate control system according to some embodiments;

FIGS. 2 - 4 are block diagrams for explaining a configuration of the flow rate control device of FIG. 1, according to some embodiments;

FIG. 5 is a block diagram for explaining an operation of a flow rate control device, according to some embodiments;

FIG. 6 is a graph for explaining a motor position of a pinch valve corresponding to a convergent flow rate that constitutes flow modulation logic;

FIG. 7 is a graph for explaining an excessive on/off rate m_a that constitutes a flow modulation logic, according to some embodiments;

FIG. 8 is a graph showing a change in flow rate of a slurry solution according to the operation of a flow rate control device, according to some embodiments;

FIG. 9 is a flowchart for explaining an operation of a flow rate control device, according to some embodiments;

FIGS. 10 and 11 are graphs in which a target flow rate and a current flow rate are compared in a comparative example and in an embodiment, respectively, with FIG. 10 illustrating the comparative example and FIG. 11 illustrating the embodiment;

FIG. 12 is a flow chart for explaining an operation of a flow rate control device, according to some embodiments;

FIGS. 13 and 14 are graphs in which a target flow rate and a current flow rate are compared in a comparative example and an embodiment; and

FIG. 15 is a block diagram for explaining a configuration of a flow rate control device according to some embodiments.

### DETAILED DESCRIPTION

It will be noted that aspects are not restricted to the ones set forth herein. The above and other aspects will become more apparent to one of ordinary skill in the art by referencing the detailed description of the various embodiments given below.

Hereinafter, various embodiments will be described in detail referring to the attached drawings. The same reference numerals are used for the same components in the drawings, and the repeated description will be omitted for conciseness.

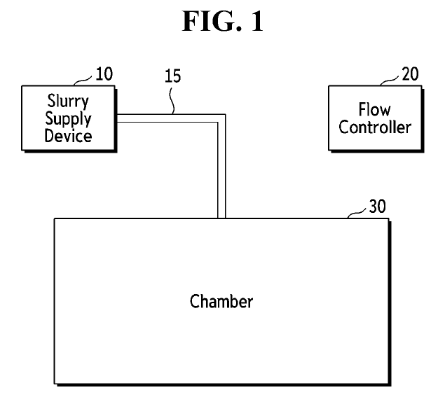

FIG. 1 is a block diagram showing a flow rate control system according to some embodiments.

Referring to FIG. 1, a flow rate control system 1 may include a slurry supply device 10, a flow rate control device 20, and a chamber 30.

The slurry supply device 10 may supply a slurry solution to the chamber 30. The slurry solution may be used for chemical polishing of a substrate inside the chamber 30.

The flow rate control device 20 may adjust an amount of the slurry solution provided to the chamber 30 from the slurry supply device 10. The flow rate control device 20 may adjust the amount of the slurry solution provided to the chamber 30 by controlling a motor position of a pinch valve (340 of FIG. 3) of a flow tube 15 connected to the chamber 30. A specific method for adjusting the amount of the slurry solution by the flow rate control device 20 will be described below.

The chamber 30 may process the substrate, using the slurry solution supplied from the slurry supply device 10. For example, the chamber 30 may perform a chemical mechanical polishing (CMP) process, using the slurry solution. However, embodiments are not limited thereto, and the chamber 30 may perform other processes other than the chemical mechanical polishing (CMP) process, using the slurry solution.

The slurry supply device 10, the flow rate control device 20, and the chamber 30 may be connected in sequence through the flow tube 15.

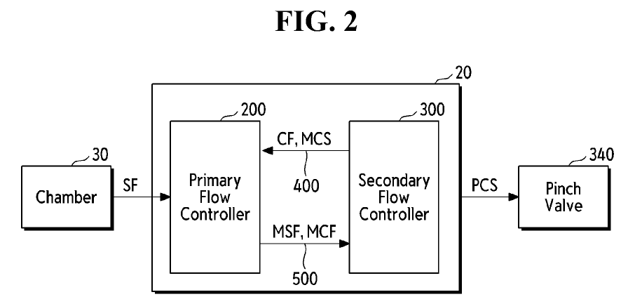

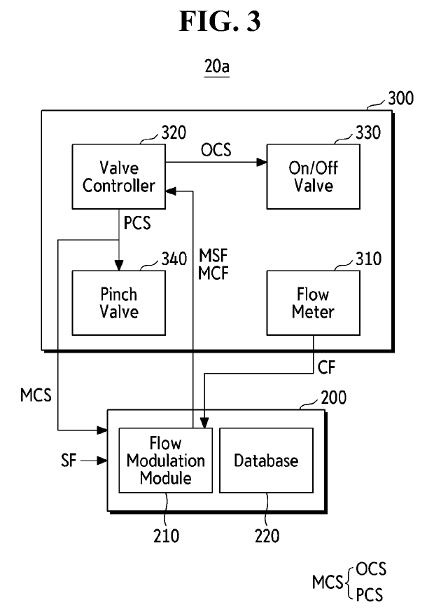

FIGS. 2 - 4 are block diagrams for explaining the configuration of the flow rate control device of FIG. 1, according to some embodiments.

Referring to FIGS. 2 - 4, the flow rate control device 20 may include a primary flow controller 200 and a secondary flow controller 300. The flow rate control device 20 of FIG. 2 may correspond to a flow rate control device 20a of FIG. 3.

The primary flow controller 200 may provide a modulated target flow rate MSF and a modulated current flow rate MCF to the secondary flow controller 300 so that a flow rate reaction rate may be improved. The secondary flow controller 300 may generate a pinch valve control signal PCS that controls a motor position of a pinch valve 340 on the basis of the modulated target flow rate MSF and the modulated current flow rate MCF. The amount of the slurry solution flowing through the flow tube 15 that connects between the slurry supply device 10 and the chamber 30 may be adjusted on the basis of the motor position of the pinch valve 340.

As shown in FIGS. 3-4, in some embodiments, the primary flow controller 200 may include an input terminal 400, an output terminal 500, a flow modulation module 210, and a database 220.

The input terminal 400 of the primary flow controller 200 may receive a target flow rate SF from the chamber 30, a current flow rate CF from the secondary flow controller 300, and a motor control signal MCS from the secondary flow controller 300. For example, as illustrated in FIG. 4, the flow modulation module 210 of the primary flow controller 200 may receive a first target flow rate SF1 in the form of an electrical signal from the chamber 30. The flow modulation module 210 of the primary flow controller 200 may receive a first current flow rate CF1 and the motor control signal MCS in the form of an electrical signal from the secondary flow controller 300.
In an embodiment, the motor control signal MCS may include a pinch valve control signal PCS and an on-off valve control signal OCS. The pinch valve control signal PCS may be an electrical signal corresponding to the motor position of the pinch valve 340 that presses the flow tube 15 that connects between the slurry supply device 10 and the chamber 30. The on-off valve control signal OCS controls the opening or closing of the flow tube 15 that connects the slurry supply device 10 and the chamber 30 to control the slurry solution to flow or not through the flow tube. That is, the on-off valve control signal OCS may control the slurry solution to flow or not through the flow tube, and the pinch valve control signal PCS may adjust the amount of slurry solution flowing through the flow tube 15 while the flow tube 15 open.

The primary flow controller 200 may generate a modulated target flow rate MSF and a modulated current flow rate MCF on the basis of the target flow rate SF and the current flow rate CF. Specifically, the flow modulation module 210 may generate a modulated target flow rate MSF and a modulated current flow rate MCF on the basis of the target flow rate SF and the current flow rate CF. For example, as illustrated in FIG. 4, a modulated target flow rate MSF and a modulated current flow rate MCF which are generated, by the flow modulation module 210, by modulating the first target flow SF1 and the first current flow rate CF1 received by the input terminal 400 may be a second target flow rate SF2 and a second current flow rate CF2. In some embodiments, the second target flow rate SF2 and the second current flow rate CF2 may be modulated to a third target flow rate SF3 and a third current flow rate CF3 in an n^{th} step (wherein n is an integer equal to or greater than 0) in which the first target flow rate SF1 is used. The first target flow rate SF1 and the first current flow rate CF1 correspond to the flow rates actually measured from the chamber 30 and the secondary flow controller 300, respectively, and the second target flow rate SF2, the second current flow rate CF2, the third target flow rate SF3 and the third current flow rate CF3 may be flow rates that are modulated in the flow modulation module 210 so that the flow rate reaction speed can be improved in the n^{th} step.

The primary flow controller 200 may provide the modulated target flow rate MSF and the modulated current flow rate MCF to the secondary flow controller 300 through an output terminal 500. For example, As illustrated in FIG. 4, the modulated target flow rate MSF and the modulated current flow rate MCF to improve the flow-rate response speed, may be the second target flow rate SF2 and the second current flow rate CF2, or the third target flow rate SF3 and the third current flow rate CF3. In some embodiments, the second target flow rate SF2 and the second current flow rate CF2, or the third target flow rate SF3 and the third current flow rate CF3 may be provided to the secondary flow controller 300 on the basis of an operation timing of the motor control signal MCS.

That is, the pinch valve control signal PCS may be generated by modulated flow rates such as the second target flow rate SF2 and the second current flow rate CF2 or the third target flow rate SF3 and the third current flow rate CF3, and the pinch valve 340 may be controlled based on the modulated flow rates. Accordingly, a flow rate control system 1 with improved flow rate reaction speed compared to adjusting the pinch valve 340 by the pinch valve control signal PCS generated by the actually measured first target flow rate SF1 and the first current flow rate CF1 may be provided.

The database 220 may include various types of data and logics used for the flow modulation module 210 to modulate the target flow rate SF and the current flow rate CF into the modulated target flow rate MSF and the modulated current flow rate MCF.

As illustrated in FIG. 3, in some embodiments, the secondary flow controller 300 may include a flow meter 310, a valve controller 320, an on-off valve 330, and the pinch valve 340.

The flow meter 310 may measure the flow rate of the slurry solution flowing along the flow tube 15. Accordingly, the current flow rate CF provided to the chamber 30 may be measured. For example, the flow rate of the slurry solution measured by the flow meter 310 may be the first current flow rate CF1.

The on-off valve 330 may control the slurry solution to flow or not through the flow tube 15 by opening or closing the flow tube 15 that connects between the slurry supply device 10 and the chamber 30. For example, when the flow tube 15 is open, the slurry solution supplied from the slurry supply device 10 may flow to the chamber 30. When the flow tube 15 is closed, the slurry solution supplied from the slurry supply device 10 may not flow to the chamber 30.

In an embodiment, the pinch valve 340 may adjust the amount of slurry solution flowing through the flow tube 15 while the flow tube 15 is open, by pressing the flow tube 15 that connects the slurry supply device 10 and the chamber 30. For example, as the flow tube 15 is pressed by a motor position of the pinch valve 340, the cross-sectional area of the flow tube 15 may decrease. Accordingly, a conductance of the flow tube 15 may increase, and the amount of slurry solution flowing through the flow tube 15 may decrease.

The valve controller 320 may generate the on-off valve control signal OCS and the pinch valve control signal PCS that control the on-off valve 330 and the pinch valve 340, respectively, provide the on-off valve control signal OCS to the on-off valve 330, and provide the pinch valve control signal PCS to the pinch valve 340. The on-off valve control signal OCS and the pinch valve control signal PCS may be generated on the basis of the modulated target flow rate MSF and the modulated current flow rate MCF provided from the primary flow controller 200. For example, the valve controller 320 may be provided with the second target flow rate SF2 and the second current flow rate CF2 or the third target flow rate SF3 and the third current flow rate CF3 that are modulated on the basis of the actually measured first target flow rate SF1 and the first current flow rate CF1. The on-off valve control signal OCS and the pinch valve control signal PCS may be generated on the basis of the second target flow rate SF2 and the second current flow rate CF2 or the third target flow rate SF3 and the third current flow rate CF3. Accordingly, a flow rate control system 1 with improved flow rate reaction speed may be provided, compared to a case of adjusting the pinch valve 340 by the pinch valve control signal PCS generated by the actually measured first target flow rate SF1 and the first current flow rate CF1.

Although the primary flow controller 200 and the secondary flow controller 300 are shown to be separated in the drawings, embodiments are not limited thereto. In some embodiments, the configuration and functions of the primary flow controller 200 and the secondary flow controller 300 may be provided in a single flow controller.

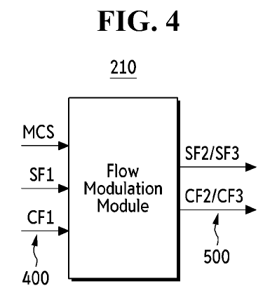

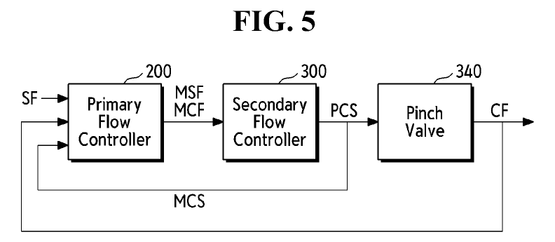

FIG. 5 is a block diagram for explaining an operation of a flow rate control device, according to some embodiments.

Referring to FIG. 5, the primary flow controller 200 may be provided with the target flow rate SF, the current flow rate CF, and the motor control signal MCS. The primary flow controller 200 may generate a modulated target flow rate MSF and a modulated current flow rate MCF on the basis of the flow modulation logic. The flow modulation logic may include the motor position of the pinch valve 340 and an excessive on/off rate m_a corresponding to a convergent flow rate.

The modulated target flow rate MSF and the modulated current flow rate MCF may be provided to the secondary flow controller 300. The secondary flow controller 300 may generate the pinch valve control signal PCS that controls the motor position of the pinch valve 340 on the basis of the modulated target flow rate MSF and the modulated current flow rate MCF. The current flow rate CF of the slurry solution flowing through the flow tube 15 that connects between the slurry supply device 10 and the chamber 30 may be adjusted on the basis of the motor position of the pinch valve 340.

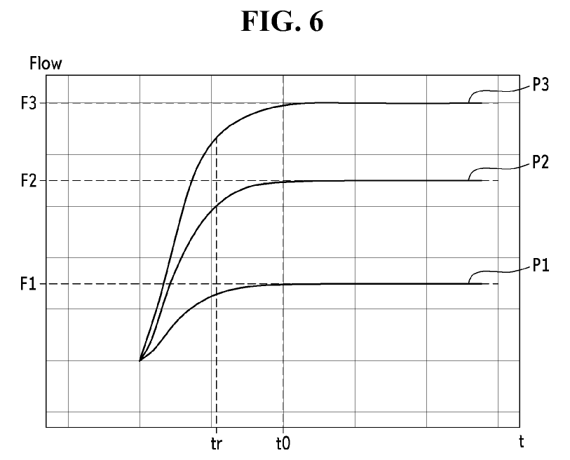

FIG. 6 is a graph for explaining a motor position of a pinch valve corresponding to a convergent flow rate that constitutes a flow modulation logic. An x-axis of the graph may represent time, and a y-axis of the graph may represent the flow rate.

Referring to FIGS. 5 and 6, the flow rate of the slurry solution flowing through the flow tube may gradually increase and then converge to a certain value, on the basis of the motor position of the pinch valve 340.

For example, when the motor position of the pinch valve 340 is a first position P1, the flow rate of the slurry solution flowing through the flow tube may converge to a first flow rate F1 after a delay of a delay time t0. When the motor position of the pinch valve 340 is a second position P2, the flow rate of the slurry solution flowing through the flow tube may converge to a second flow rate F2 after a delay of the delay time t0. When the motor position of the pinch valve 340 is a third position P3, the flow rate of the slurry solution flowing through the flow tube may converge to a third flow rate F3 after a delay of the delay time t0.

In some embodiments, the flow modulation logic may include a correspondence between the motor position of the pinch valve 340 and the convergent flow rate. For example, the target flow rate SF provided to the primary flow controller 200 may be the first flow rate F1. The motor position of the pinch valve 340 that converges to the first flow rate F1 may be the first position P1. However, due to the fluidity of the slurry solution and the feedback control characteristics of the pinch valve 340, a delay may occur until the target flow rate SF (e.g., the first flow rate F1) corresponding to the motor position of the pinch valve 340 (e.g., the first position P1) is reached. Therefore, the target flow rate SF may not be reached within a target reaction time tr simply by adjusting the motor position of the pinch valve 340 depending on the target flow rate SF. In order to provide a flow rate control system 1 for reaching the target flow rate SF within the target reaction time tr, it may be advantageous to control the motor position of the pinch valve 340 by the modulated target flow rate MSF.

In some embodiments, the motor position of the pinch valve 340 corresponding to the convergent flow rate may be in the form of a table or function, but embodiments are not limited thereto, and the motor position of the pinch valve 340 corresponding to the convergent flow rate may be configured in various forms.

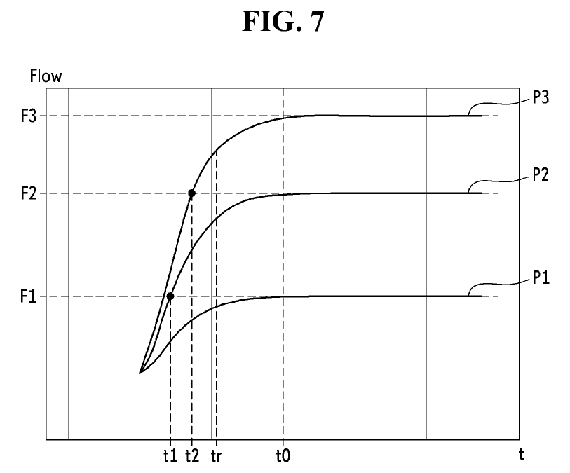

FIG. 7 is a graph for explaining an excessive on/off rate m_a that constitutes a flow modulation logic. An x-axis of the graph may represent time, and a y-axis of the graph may represent flow rate.

Referring to FIGS. 5 - 7, the flow rate of the slurry solution flowing through the flow tube 15 may gradually increase and then converge to a specific value on the basis of the motor position of the pinch valve 340. That is, a delay may occur until the target flow rate SF is reached. For example, when the motor position of the pinch valve 340 is the first position P1, the second position P2, and the third position P3, the flow rate of the slurry solution flowing through the flow tube 15 may converge to the first flow rate F1, the second flow rate F2, and the third flow rate F3, respectively, after a delay of the delay time t0. Therefore, when the target reaction time tr is smaller than the delay time t0, the flow rate of the slurry solution supplied to the chamber 30 may not reach the target flow rate SF within the target reaction time tr. However, embodiments are not limited thereto, and the delay time t0 may vary depending on the motor position of each pinch valve 340.

For example, when the target flow rate SF provided in the chamber 30 is the first flow rate F1, if the motor position of the pinch valve 340 is the first position P1, the first flow rate F1 may not be reached within the target reaction time tr. However, if the motor position of the pinch valve 340 is the second position P2, the first flow rate F1 may be reached after the first time t1. The first time t1 may be shorter than the target reaction time tr. The flow rate of the slurry solution corresponding to the motor position of the pinch valve 340 of the second position P2 may be a second flow rate F2 that is greater than the first flow rate F1.

When the target flow rate SF provided in the chamber 30 is the second flow rate F2, if the motor position of the pinch valve 340 is the second position P2, the second flow rate F2 may not be reached within the target reaction time tr. However, if the motor position of the pinch valve 340 is the third position P3, the second flow rate F2 may be reached after a second time t2. The second time t2 may be shorter than the target reaction time tr. The flow rate of the slurry solution corresponding to the motor position of the pinch valve 340 of the third position P3 may be a third flow rate F3 that is greater than the second flow rate F2.

That is, the excessive opening/closing ratio m_a may be a value that is multiplied by the motor position of the pinch valve 340 corresponding to the target flow rate SF to calculate the motor position of the pinch valve 340 which causes the flow rate of the slurry solution flowing through the flow tube to reach the target flow rate SF within the target reaction time tr. The excessive opening/closing ratio m_a may be a value calculated experimentally.

As a result, the flow modulation logic is provided with the target flow rate SF and the current flow rate CF, and may generate a modulated target flow rate MSF and a modulated current flow rate MCF on the basis of the motor position of the pinch valve 340 corresponding to the convergent flow rate and the excessive on/off rate m_a. Therefore, a flow rate control system 1 with improved flow rate reaction speed may be provided.

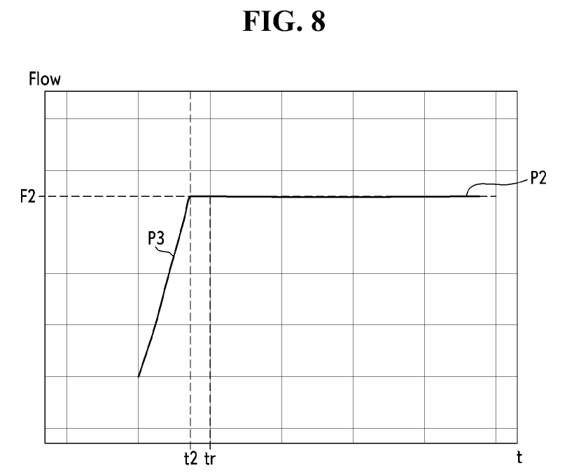

FIG. 8 is a graph showing a change in flow rate of a slurry solution according to an operation of a flow rate control device, according to some embodiments.

Referring to FIGS. 5 - 8, in some embodiments, the target flow rate SF provided to the primary flow controller 200 may be the second flow rate F2. The motor position of the pinch valve 340 which causes a convergence to the second flow rate F2 may be the second position P2. However, a delay may occur until the second flow rate F2 is reached, due to the fluidity of the slurry solution and the feedback control characteristics of the pinch valve 340. As a result, the target flow rate SF may not be reached within the target reaction time tr.

However, if the motor position of the pinch valve 340 is the third position P3, the second flow rate F2 may be reached after the second time t2. The second time t2 may be shorter than the target reaction time tr.

Therefore, the primary flow controller 200 may generate a modulated target flow rate MSF and a modulated current flow rate MCF of the pinch valve 340 for moving to the motor position (e.g., the third position P3) of the pinch valve 340 obtained by multiplying the second position P2 by the excessive on/off rate m_a in a first section (e.g., before the second time t2) before the second flow rate F2 (or within a certain error rate range from the second flow rate F2) is reached, and may provide the modulated target flow rate MSF and the modulated current flow rate MCF to the secondary flow controller 300.

The primary flow controller 200 may provide a modulated target flow rate MSF and a modulated current flow rate MCF for moving the motor position of the pinch valve 340 to the second position P2 again in a second section (e.g., after the second time t2) before the second flow rate F2 (or within a certain error rate range from the second flow rate F2) is reached, and may provide the modulated target flow rate MSF and the modulated current flow rate MCF to the secondary flow controller 300. That is, the reaction speed of the pinch valve 340 may be improved. Accordingly, it is possible to provide a flow rate control system 1 for reaching the target flow rate SF within the target reaction time tr.

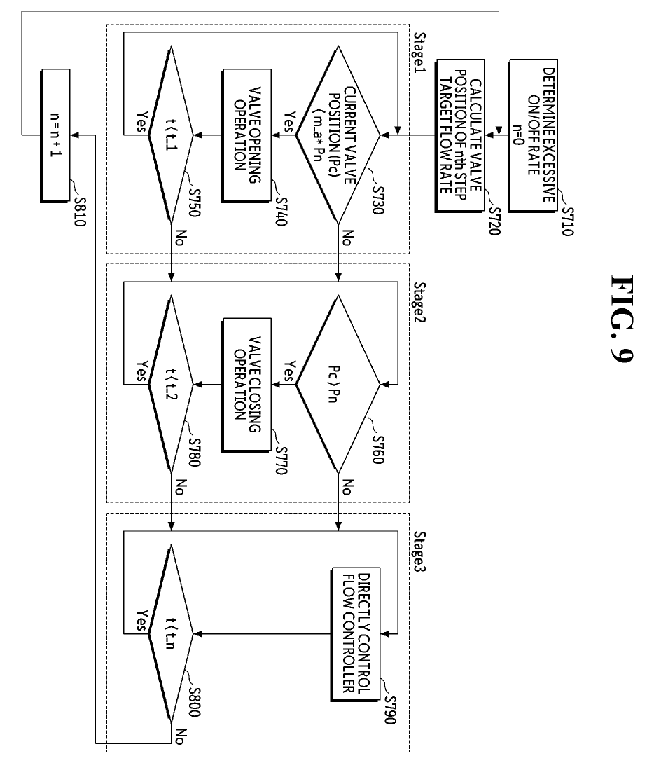

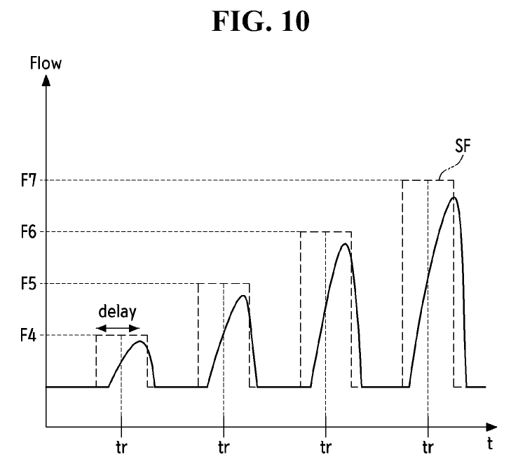

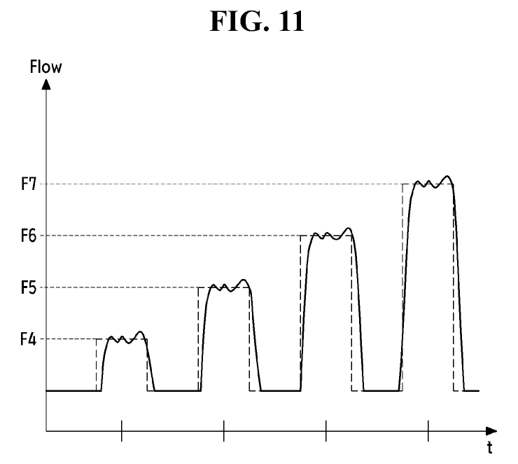

FIG. 9 is a flowchart for explaining an operation of a flow rate control device, according to some embodiments. FIGS. 10 and 11 are graphs in which a target flow rate and a current flow rate are compared in a comparative example and in an embodiment. FIG. 10 illustrates a comparative example and FIG. 11 illustrates an embodiment.

Referring to FIGS. 5, 9 and 11, the primary flow controller 200 of the flow rate control device 20 for providing the target flow rate SF to the chamber 30 may generate a modulated target flow rate MSF and a modulated current flow rate MCF on the basis of the flow modulation logic. The flow modulation logic may include a correspondence between a motor position of the pinch valve 340 and a convergent flow rate, and an excessive on/off rate m_a (S710).

A series of operations of the flow rate control device 20 for providing the target flow rate SF to the chamber 30 may include plurality of steps. Each of the plurality of steps may be divided by the on-off valve 330. For example, the n^{th} step may include a first open section in which the on-off valve is in an open state, and a first closed section in which the on-off valve is in a closed state. In the first open section, the target flow rate SF may be a fifth flow rate F5. A (n+1)^{th} step may include a second open section in which the on-off valve is in an open state, and a second closed section in which the on-off valve is in a closed state. In the second open section, the target flow rate SF may be a sixth flow rate F6.

The plurality of steps may include a plurality of stages for the flow rate control device 20 to provide the target flow rate SF to the chamber 30. Each of the plurality of stages may include a first stage (stage 1), a second stage (stage 2), and a third stage.

The first stage (stage 1) may correspond to an excessive on/off stage. The second stage (stage 2) may correspond to a stabilization stage. The third stage (stage 3) may correspond to a feedback stage. The first stage (stage 1) may correspond to the first section described with respect to FIG. 8, and the second stage 2 may correspond to the second section described with respect to FIG. 8. The third stage (stage 3) may be a section in which the change in flow rate due to other external factors (e.g., aging of the flow tube, etc.) is controlled by feedback after the target flow rate SF is reached.

In the n^{th} step (wherein n is an integer equal to or greater than 0) of the plurality of steps, the flow rate control device 20 may calculate the motor position of the pinch valve 340 corresponding to the target flow rate SF of the n^{th} step on the basis of the flow modulation logic (S720).

In some embodiments, the target flow rate SF provided to the chamber 30 may increase as each step progresses. For example, the target flow rate SF of the (n-1)^{th} step may be a fourth flow rate F4, the target flow rate SF of the n^{th} step may be a fifth flow rate F5, and the target flow rate SF of the (n+1)^{th} step may be a sixth flow rate F6. The fifth flow rate F5 may be greater than the fourth flow rate F4, and the sixth flow rate F6 may be greater than the fifth flow rate F5.

According to the correspondence between the motor position of the pinch valve 340 of the flow modulation logic and the convergent flow rate, the motor position of the pinch valve 340 corresponding to the fifth flow rate F5, which is the target flow rate SF of the n^{th} step, may be an n^{th} position Pn.

In the first stage (stage 1) of the n^{th} step, a current valve position Pc based on the current flow rate CF may be compared with an excessive on/off valve position m_a*Pn calculated by multiplying the n^{th} position Pn of the pinch valve 340 by the excessive on/off rate m_a (S730).

When the excessive on/off valve position m_a*Pn is greater than the current valve position Pc (S730, Yes), the flow rate control device 20 may perform a series of operations for opening the pinch valve 340 (S740). Specifically, the primary flow controller 200 may provide the secondary flow controller 300 with the modulated target flow rate MSF and the modulated current flow rate MCF which cause the pinch valve 340 to open to the excessive on/off valve position m_a*Pn. The secondary flow controller 300 may generate a pinch valve control signal PCS on the basis of the modulated target flow rate MSF and the modulated current flow rate MCF, and provide the pinch valve control signal PCS to the pinch valve 340.

However, if the excessive on/off valve position m_a*Pn is smaller than or equal to the current valve position Pc (S730, No), the flow rate control device 20 may perform a series of operations included in the second stage (stage 2) of the n^{th} step.

After the flow rate control device 20 performs the series of operations for opening the pinch valve 340, it may be determined whether an elapsed time t within the n^{th} step exceeds a first tuning time t_1 assigned to the first stage (stage 1) (S750).

If the elapsed time t within the n^{th} step exceeds a first tuning time t_1 assigned to the first stage (stage 1) (S750, No), the flow rate control device 20 may perform a series of operations included in the second stage (stage 2) of the n^{th} step.

If the elapsed time t within the n^{th} step does not exceed the first tuning time t_1 assigned to the first stage (stage 1) (S750, Yes), a series of operations for opening the pinch valve 340 may be performed until the excessive on/off valve position m_a*Pn is smaller than or equal to the current valve position Pc (i.e., the process may return to S730).

In the second stage (stage 2) of the n^{th} step, the current valve position Pc based on the current flow rate CF may be compared with the n^{th} position Pn of the pinch valve 340 (S760).

If the n^{th} position Pn is smaller than the current valve position Pc (S760, Yes), the flow rate control device 20 may perform a series of operations for closing the pinch valve 340 (S770). Specifically, the primary flow controller 200 may provide the secondary flow controller 300 with a modulated target flow rate MSF and a modulated current flow rate MCF that cause the pinch valve 340 to be closed to the n^{th} position Pn. The secondary flow controller 300 may generate a pinch valve control signal PCS on the basis of the modulated target flow rate MSF and the modulated current flow rate MCF, and provide the pinch valve control signal PCS to the pinch valve 340.

However, if the n^{th} position Pn is smaller than or equal to the current valve position Pc (S760, No), the flow rate control device 20 may perform a series of operations included in the third stage (stage 3) of the n^{th} step.

After the flow rate control device 20 performs the series of operations for closing the pinch valve 340, it may be determined whether the elapsed time t within the n^{th} step exceeds a second tuning time t_2 assigned to the second stage (stage 2) (S780).

If the elapsed time t within the n^{th} step exceeds a second tuning time t_2 assigned to the second stage (stage 2) (S780, No), the flow rate control device 20 may perform a series of operations included in the third stage (stage 3) of the n^{th} step.

If the elapsed time t within the n^{th} step does not exceed the second tuning time t_2 assigned to the second stage (stage 2) (S780, Yes), the flow rate control device 20 may perform a series of operations for closing the pinch valve 340 until the n^{th} position Pn is greater than or equal to the current valve position Pc (i.e., the process may return to S760).

In the third stage (stage 3) of the n^{th} step, the flow rate control device 20 may control the change in flow rate due to other external factors (e.g., aging of the flow tube) by feedback (S790).

It may be determined whether the elapsed time t within the n^{th} step exceeds the n^{th} tuning time t_n assigned to the n^{th} step (S800).

If the elapsed time t within the n^{th} step does not exceed the n^{th} tuning time t_n assigned to the n^{th} step (S800, Yes), the flow rate control device 20 may control the change in flow rate due to other external factors (e.g., aging of the flow tube, etc.) by feedback (S790).

If the elapsed time t within the n^{th} step exceeds the n^{th} tuning time t_n assigned to the n^{th} step (S800, No), the (n+1)^{th} step may be performed (S810).

In the (n+1)^{th} step (where n is an integer equal to or greater than 0), the flow rate control device 20 may calculate the motor position of the pinch valve 340 corresponding to the target flow rate SF of the (n+1)^{th} step on the basis of the flow modulation logic (S720).

For example, the target flow rate SF of the (n+1)^{th} step may be the sixth flow rate F6. According to the correspondence between the motor position of the pinch valve 340 of the flow modulation logic and the convergent flow rate, the motor position of the pinch valve 340 corresponding to the sixth flow rate F6 may be the (n+1)^{th} position Pn+1.

In the first stage (stage 1) of the (n+1)^{th} step, the current valve position Pc based on the current flow rate CF may be compared with an excessive on/off valve position (Pn+1×m_a) calculated by multiplying and the (n+1)^{th} position Pn+1 of the pinch valve 340 by the excessive on/off rate m_a.

In this way, if the target flow rate SF provided to the chamber 30 increases as each step progresses, the pinch valve 340 may be controlled through the modulated target flow rate MSF and the modulated current flow rate MCF on the basis of the excessive on/off rate m_a. As a result, the flow rate control device 20 may quickly respond to the position of the pinch valve 340 corresponding to the flow rate that rapidly rises. Thereafter, the operation of the (n+1)^{th} step may be explained in the same manner as the n^{th} step.

Referring to FIG. 10, in the case of a comparative example that does not include an excessive on/off stage, because a delay occurs until the target flow rate SF is reached in each individual step, the target flow rate SF may not be reached within the target reaction time tr, but also it is not possible to quickly correspond to the position of the pinch valve 340 corresponding to the rapidly rising flow rate while plurality of steps are performed.

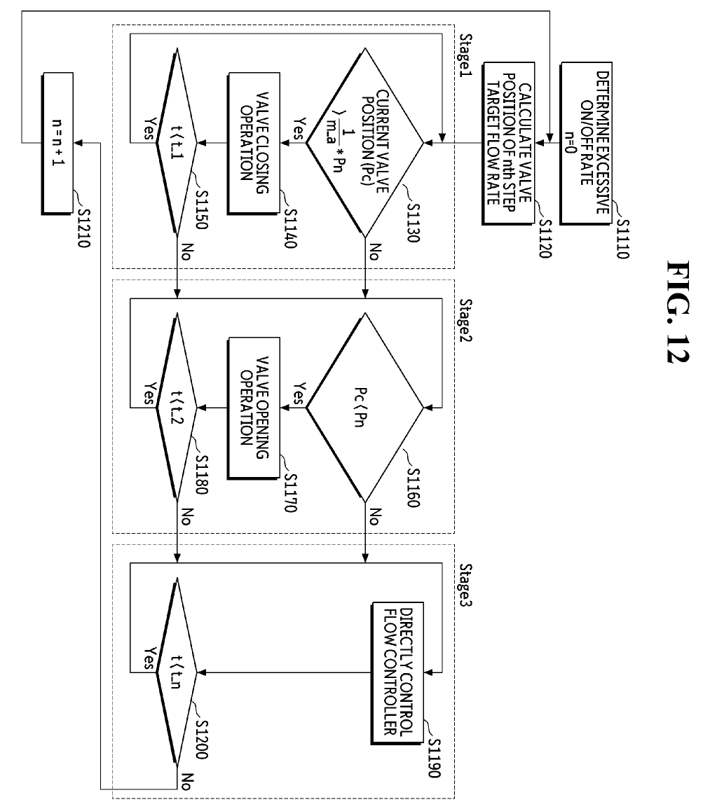

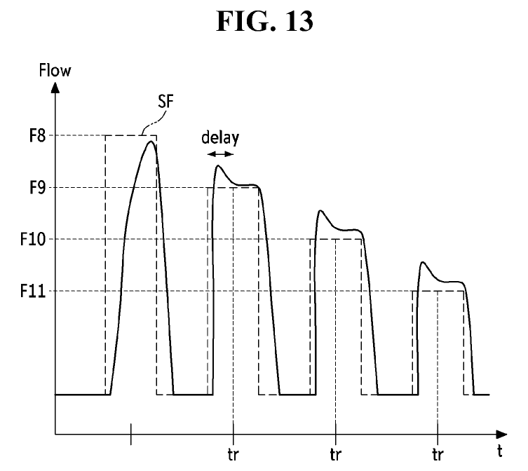

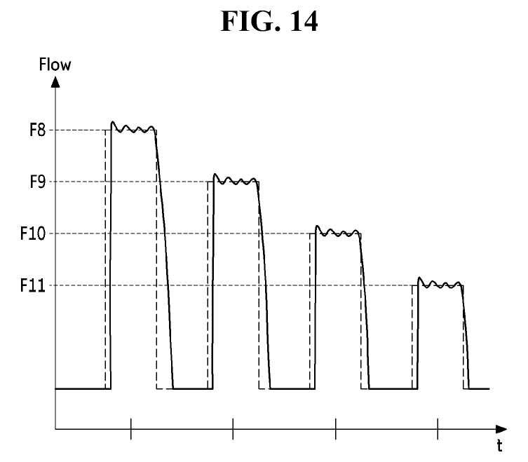

FIG. 12 is a flow chart for explaining an operation of a flow rate control device, according to some embodiments. FIGS. 13 and 14 are graphs in which a target flow rate and a current flow rate are compared in a comparative example and in an embodiment, where FIG. 13 illustrates a comparative example and FIG. 14 illustrates an embodiment.

Referring to FIGS. 5, 12 and 14, a series of operations of the flow rate control device 20 for providing the target flow rate SF to the chamber 30 may include a plurality of steps. Each of the plurality of steps may be divided by the on-off valve 330. For example, the n^{th} step may include a first open section in which the on-off valve is in an open state, and a first closed section in which the on-off valve is in a closed state. In the first open section, the target flow rate SF may be a ninth flow rate F9. The (n+1)^{th} step may include a second open section in which the on-off valve is in the open state, and a second closed section in which the on-off valve is in the closed state. In the second open section, the target flow rate SF may be a tenth flow rate F10.

The primary flow controller 200 of the flow rate control device 20 for providing the target flow rate SF to the chamber 30 may generate a modulated target flow rate MSF and a modulated current flow rate MCF on the basis of the flow modulation logic. The flow modulation logic may include a correspondence between a motor position of the pinch valve 340 and a convergent flow rate, and an excessive on/off rate m_a (S1110).

A series of operations of the flow rate control device 20 for providing the target flow rate SF to the chamber 30 may include a plurality of steps. Each of the plurality of steps may include a plurality of stages for the flow rate control device 20 to provide the target flow rate SF to the chamber 30. Each of the plurality of stages may include a first stage (stage 1), a second stage (stage 2), and a third stage.

The first stage (stage 1) may correspond to an excessive on/off stage. The second stage (stage 2) may correspond to a stabilization stage. The third stage (stage 3) may correspond to a feedback stage. The first stage (stage 1) may correspond to the first section described through FIG. 8, and the second stage 2 may correspond to the second section described through FIG. 8. The third stage (stage 3) may be a section in which the change in flow rate due to other external factors (e.g., aging of the flow tube etc.) is controlled by feedback after the target flow rate SF is reached.

In the n^{th} step (where n is an integer equal to or greater than 0) of the plurality of steps, the flow rate control device 20 may calculate the motor position of the pinch valve 340 corresponding to the target flow rate SF of the n^{th} step on the basis of the flow modulation logic (S1120).

In some embodiments, the target flow rate SF provided to the chamber 30 may decrease as each step progresses. For example, the target flow rate SF of the (n-1)^{th} step may be the eighth flow rate F8, the target flow rate SF of the n^{th} step may be the ninth flow rate F9, and the target flow rate SF of the (n+1)^{th} step may be the tenth flow rate F10. The eighth flow rate F8 may be greater than the ninth flow rate F9, and the ninth flow rate F9 may be greater than the tenth flow rate F10.

According to the correspondence between the motor position of the pinch valve 340 of the flow modulation logic and the convergent flow rate, the motor position of the pinch valve 340 corresponding to the ninth flow rate F9, which is the target flow rate SF of the n^{th} step, may be the n^{th} position Pn.

In the first stage (stage 1) of the n^{th} step, the current valve position Pc based on the current flow rate CF may be compared with the excessive on/off valve position Pn/m_a calculated by multiplying the n^{th} position Pn of the pinch valve 340 by a reciprocal 1/m_a of the excessive on/off rate.

If the excessive on/off valve position Pn/m_a is smaller than the current valve position Pc (S1130, Yes), the flow rate control device 20 may perform a series of operations for closing the pinch valve 340 (S1140). Specifically, the primary flow controller 200 may provide the secondary flow controller 300 with a modulated target flow rate MSF and a modulated current flow rate MCF which cause the pinch valve 340 to be closed to the excessive on/off valve position Pn/m_a. The secondary flow controller 300 may generate a pinch valve control signal PCS on the basis of the modulated target flow rate MSF and the modulated current flow rate MCF, and provide the pinch valve control signal PCS to the pinch valve 340.

However, if the excessive on/off valve position Pn/m_a is greater than or equal to the current valve position Pc (S1130, No), the flow rate control device 20 may perform a series of operations included in the second stage (stage 2) of the n^{th} step.

After the flow rate control device 20 performs the series of operations for closing the pinch valve 340, it may be determined whether the elapsed time t within the n^{th} step exceeds the first tuning time t_1 assigned to the first stage (stage 1) (S1150).

If the elapsed time t within the n^{th} step exceeds the first tuning time t_1 assigned to the first stage (stage 1) (S1150, No), the flow rate control device 20 may perform a series of operations included in the second stage (stage 2) of the n^{th} step.

If the elapsed time t within the n^{th} step does not exceed the first tuning time t_1 assigned to the first stage (stage 1) (S1150, Yes), the flow rate control device 20 may perform a series of operations for closing the pinch valve 340, until the excessive on/off valve position Pn/m_a is greater than or equal to the current valve position (Pc) (i.e., the process may return to S1130).

In the second stage (stage 2) of the n^{th} step, the current valve position Pc based on the current flow rate CF may be compared with the n^{th} position Pn of the pinch valve 340 (S1160).

If the n^{th} position Pn is greater than the current valve position Pc (S1160, Yes), the flow rate control device 20 may perform a series of operations for opening the pinch valve 340 (S1170). Specifically, the primary flow controller 200 may provide the secondary flow controller 300 with a modulated target flow rate MSF and a modulated current flow rate MCF that cause the pinch valve 340 to open to the n^{th} position Pn. The secondary flow controller 300 may generate the pinch valve control signal PCS on the basis of the modulated target flow rate MSF and the modulated current flow rate MCF, and provide the pinch valve control signal PCS to the pinch valve 340.

However, if the n^{th} position Pn is smaller than or equal to the current valve position Pc (S1160, No), the flow rate control device 20 may perform a series of operations included in the third stage (stage 3) of the n^{th} step.

After the flow rate control device 20 performs the series of operations for opening the pinch valve 340, it may be determined whether the elapsed time t within the n^{th} step exceeds the second tuning time t_2 assigned to the second stage (stage 2) (S1180).

If the elapsed time t within the n^{th} step exceeds the second tuning time t_2 assigned to the second stage (stage 2) (S1180, No), the flow rate control device 20 may perform a series of operations included in the third stage (stage 3) of the n^{th} step.

If the elapsed time t within the n^{th} step does not exceed the second tuning time t_2 assigned to the second stage (stage 2) (S1180, Yes), the flow rate control device 20 may perform a series of operations for opening the pinch valve 340, until the nth position Pn is smaller than or equal to the current valve position Pc (i.e., the process may return to S1160).

In the third stage (stage 3) of the n^{th} step, the flow rate control device 20 may control the change in flow rate due to other external factors (e.g., aging of the flow tube) by feedback (S1190).

It may be determined whether the elapsed time t within the n^{th} step exceeds the n^{th} tuning time t_n assigned to the n^{th} step (S1200).

If the elapsed time t within the n^{th} step does not exceed the n^{th} tuning time t_n assigned to the n^{th} step (S1200, Yes), the flow rate control device 20 may control the change in flow rate due to other external factors (e.g., aging of the flow tube, etc.) by feedback (S1190).

If the elapsed time t within the n^{th} step exceeds the n^{th} tuning time t_n assigned to the n^{th} step (S1200, No), the (n+1)^{th} step may be performed (S1210).

In the (n+1)^{th} step (n is an integer equal to or greater than 0), the flow rate control device 20 may calculate the motor position of the pinch valve 340 corresponding to the target flow rate SF of the (n+1)^{th} step on the basis of the flow modulation logic (S1120).

For example, the target flow rate SF of the (n+1)^{th} step may be the tenth flow rate F10. According to the correspondence between the motor position of the pinch valve 340 of the flow modulation logic and the convergent flow rate, the motor position of the pinch valve 340 corresponding to the tenth flow rate F10 may be the (n+1)^{th} position Pn+1.

In the first stage (stage1) of the (n+1)^{th} step, the current valve position Pc based on the current flow rate CF may be compared with the excessive on/off valve position (Pn+1/m_a) calculated by multiplying the (n+1)^{th} position Pn+1 of the pinch valve 340 by the reciprocal (1/m_a) of the excessive on/off rate.

In this way, if the target flow rate SF provided to the chamber 30 decreases as each step progresses, the pinch valve 340 may be controlled through the modulated target flow rate MSF and the modulated current flow rate MCF on the basis of the reciprocal (1/m_a) of the excessive on/off rate. Accordingly, the flow rate control device 20 may quickly respond to the position of the pinch valve 340 corresponding to the flow rate that rapidly decreases. Thereafter, the operation of the (n+1)^{th} step may be described in the manner similar to the n^{th} step.

Referring to FIG. 13, in the case of a comparative example that does not include an excessive on/off stage, because a delay occurs until the target flow rate SF is reached in each individual step, the target flow rate SF may not be reached within the target reaction time tr, but also it is not possible to rapidly response to the position of the pinch valve 340 corresponding to a flow rate that rapidly decreases while the plurality of steps are performed.

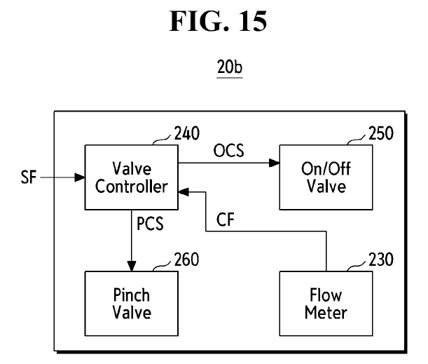

FIG. 15 is a block diagram for explaining a configuration of a flow rate control device according to some embodiments. FIG. 15 corresponds to FIG. 3, and the differences from FIG. 3 will be mainly explained.

Referring to FIGS. 2 and 15, the flow rate control device 20b may include a flow meter 230, a valve controller 240, an on-off valve 250, and a pinch valve 260. The valve controller 240 of FIG. 15 may include both the functions of the primary flow controller 200 and the secondary flow controller 300 of FIG. 3.

In some embodiments, the valve controller 240 and generate an on-off valve control signal OCS and a pinch valve control signal PCS for controlling the on-off valve 250 and the pinch valve 260, respectively, provide the on-off valve control signal OCS to the on-off valve 250, and provide the pinch valve control signal PCS to the pinch valve 260.

The on-off valve control signal OCS and the pinch valve control signal PCS may be generated on the basis of the modulated target flow rate MSF and the modulated current flow rate MCF. For example, the valve controller 240 may generate the modulated target flow rate MSF and the modulated current flow rate MCF on the basis of the actually measured target flow rate SF and the current flow rate CF. Further, the on-off valve control signal OCS and the pinch valve control signal PCS may be generated on the basis of the modulated target flow rate MSF and the modulated current flow rate MCF. As a result, it is possible to provide a flow rate control system 1 with an improved flow rate reaction speed, compared to adjusting the pinch valve 260 by the pinch valve control signal PCS generated by the actually measured first target flow rate SF and the first current flow rate CF.

The pinch valve control signal PCS may be an electrical signal corresponding to a motor position of the pinch valve 260 that presses the flow tube 15 that connects the slurry supply device 10 and the chamber 30. The on-off valve control signal OCS may control the slurry solution to flow or not through the flow tube, by controlling the opening or closing of the flow tube 15 that connects the slurry supply device 10 and the chamber 30. That is, the on-off valve control signal OCS may control the slurry solution to flow or not through the flow tube 15, and the pinch valve control signal PCS may adjust the amount of slurry solution flowing through the flow tube 15 while the flow tube 15 is open.

The flow meter 230 may measure the flow rate of the slurry solution flowing along the flow tube inside the flow rate control device 20b. Accordingly, the current flow rate CF provided to the chamber 30 may be measured.

The on-off valve 250 may control the slurry solution to flow or not through the flow tube 15 by opening or closing the flow tube 15 that connects the slurry supply device 10 and the chamber 30. For example, when the flow tube 15is open, the slurry solution supplied from the slurry supply device 10 may flow to the chamber 30. When the flow tube 15 is closed, the slurry solution supplied from the slurry supply device 10 may not flow to the chamber 30.

The pinch valve 260 may adjust the amount of slurry solution flowing through the flow tube 15 while the flow tube 15 is open by pressing the flow tube 15 that connects the slurry supply device 10 and the chamber 30. For example, as the flow tube 15 is pressed by the motor position of the pinch valve 260, the cross-sectional area of the flow tube 15 may decrease. Accordingly, the conductance of the flow tube 15 may increase, and the amount of slurry solution flowing through the flow tube 15 may decrease.

Although various embodiments have been described above with reference to the accompanying drawings, the scope of the present disclosure is not limited to the above embodiments, and embodiments may be fabricated in various different forms. Those skilled in the art will appreciate that the present disclosure may be embodied in other specific forms without changing the technical spirit or essential features of the present disclosure. Accordingly, the above-described embodiments should be understood in all respects as illustrative and not restrictive and any modifications and changes are to be included within the scope of the amended claims.

What is claimed is:

1. A flow rate control device comprising;
an input terminal that is configured to receive:
from a chamber that processes a substrate, a target flow rate of a fluid used for processing the substrate,
from a flow controller, a current flow rate of the fluid that is supplied to the chamber, and
a motor control signal for controlling a flow rate of the fluid provided to the chamber;
a flow modulation module which modulates the target flow rate and the current flow rate so that the fluid is provided to the chamber at the target flow rate within a target reaction time; and
an output terminal which provides the modulated target flow rate and the modulated current flow rate to the flow controller.

2. The flow rate control device of claim 1, wherein the flow controller includes:
a flow meter which measures the current flow rate flowing through a flow tube that provides the fluid to the chamber,
a pinch valve which adjusts the flow rate of the fluid provided through the flow tube to the chamber, and
a valve controller which controls a position of the pinch valve.

3. The flow rate control device of claim 2,
wherein the flow modulation module is provided with a first target flow rate from the chamber and modulates the first target flow rate to generate a second target flow rate,
the flow modulation module is provided with a first current flow rate from the flow controller and modulates the first current flow rate to generate a second current flow rate,
the second target flow rate is greater than the first target flow rate,
a first position of the pinch valve causes a convergent flow rate of the fluid provided to the chamber to be the first target flow rate, and
a second position of the pinch valve causes the convergent flow rate of the fluid provided to the chamber to be the second target flow rate.

4. The flow rate control device of claim 3,
wherein the motor control signal includes a pinch valve control signal that controls the pinch valve, and
the valve controller is provided with the second target flow rate and the second current flow rate, and provides the pinch valve with a first pinch valve control signal based on the second target flow rate and the second current flow rate for controlling the pinch valve to be positioned at the second position.

5. The flow rate control device of claim 4, wherein in response to the position of the pinch valve reaching the second position:
the flow modulation module generates a third target flow rate and a third current flow rate and provides the third target flow rate and the third current flow rate to the valve controller,
the valve controller provides a second pinch valve control signal to the pinch valve based on the third target flow rate and the third current flow rate, and
the second pinch valve control signal controls the pinch valve to be positioned at the first position.

6. The flow rate control device of claim 2, wherein:
the flow controller further includes an on-off valve that cuts off a supply of the fluid provided to the chamber,
the flow modulation module is provided with a first target flow rate from the chamber and modulates the first target flow rate to generate a second target flow rate,
the flow modulation module is provided with a first current flow rate from the flow controller and modulates the first current flow rate to generate a second current flow rate,
the second target flow rate is greater than the first target flow rate,
a first position of the pinch valve causes a convergent flow rate of the fluid provided to the chamber to be the first target flow rate, and
a second position of the pinch valve which causes the convergent flow rate of the fluid provided to the chamber to be the second target flow rate.

7. The flow rate control device of claim 6,
wherein the motor control signal includes an on-off valve control signal for controlling the on-off valve,
the on-off valve control signal controls the on-off valve to open in a first open section that provides the first target flow rate to the chamber,
the on-off valve control signal controls the on-off valve to open in a second open section that provides a fourth target flow rate different from the first target flow rate to the chamber, and
the on-off valve control signal controls the on-off valve to be closed in a first closed section between the first open section and the second open section.

8. The flow rate control device of claim 7,
wherein in the second open section, the flow modulation module is provided with the fourth target flow rate from the chamber and modulates the fourth target flow rate to generate a fifth target flow rate,
the flow modulation module is provided with a fourth current flow rate from the flow controller and modulates the fourth current flow rate to generate a fifth current flow rate,
a magnitude of the fourth target flow rate is smaller than a magnitude of the first target flow rate,
the motor control signal includes a pinch valve control signal for controlling the pinch valve,
the fifth target flow rate is smaller than the fourth target flow rate,
a fourth position of the pinch valve causes the convergent flow rate of the fluid provided to the chamber to be the fourth target flow rate,
a fifth position of the pinch valve causes the convergent flow rate of the fluid provided to the chamber to be the fifth target flow rate,
the valve controller is provided with the fifth target flow rate and the fifth current flow rate, and
the valve controller provides the pinch valve with a third pinch valve control signal for controlling the pinch valve to be positioned at the fifth position.

9. The flow rate control device of claim 8,
wherein a ratio of the second position to the first position is equal to a ratio of the fourth position to the fifth position.

10. The flow rate control device of claim 7, wherein in the second open section:
the flow modulation module is provided with the fourth target flow rate from the chamber and modulates the fourth target flow rate to generate a fifth target flow rate,
the flow modulation module is provided with a fourth current flow rate from the flow controller and modulates the fourth current flow rate to generate a fifth current flow rate,
a magnitude of the fourth target flow rate is greater than a magnitude of the first target flow rate,
the motor control signal includes a pinch valve control signal for controlling the pinch valve,
the fifth target flow rate is greater than the fourth target flow rate,
a fourth position of the pinch valve causes the convergent flow rate of the fluid provided to the chamber to be the fourth target flow rate,
a fifth position of the pinch valve causes the convergent flow rate of the fluid provided to the chamber to be the fifth target flow rate, and
the valve controller is provided with the fifth target flow rate and the fifth current flow rate, and provides the pinch valve with a third pinch valve control signal for controlling the pinch valve to be positioned at the fifth position.

11. The flow rate control device of claim 10,
wherein a ratio of the second position to the first position is equal to a ratio of the fifth position to the fourth position.

12. A method for operating a flow rate control device, the method comprising;
receiving a target flow rate of a fluid used to process a substrate, from a chamber for processing the substrate;
receiving, from a flow controller, a current flow rate of fluid supplied to the chamber and a motor control signal for controlling a flow rate of fluid provided to the chamber;
modulating the target flow rate and the current flow rate such that the fluid is provided to the chamber at the target flow rate within a target reaction time; and
providing the flow controller with the modulated target flow rate and the modulated current flow rate.

13. The method for operating the flow rate control device of claim 12, wherein the flow controller includes:
a flow meter which measures the current flow rate flowing through a flow tube that provides the fluid to the chamber,
a pinch valve which adjusts a flow rate of the fluid provided to the chamber, and
a valve controller which controls a position of the pinch valve.

14. The method for operating the flow rate control device of claim 13, wherein the modulating includes:
receiving a first target flow rate from the chamber and modulating the first target flow rate to generate a second target flow rate, and
receiving a first current flow rate from the flow controller and modulating the first current flow rate to generate a second current flow rate,
wherein the second target flow rate is greater than the first target flow rate,
a first position of the pinch valve causes a convergent flow rate of the fluid provided to the chamber to be the first target flow rate, and
a second position of the pinch valve which causes the convergent flow rate of the fluid provided to the chamber to be the second target flow rate.

15. The method for operating the flow rate control device of claim 14, wherein:
the motor control signal includes a pinch valve control signal for controlling the pinch valve, and
the valve controller is provided with the second target flow rate and the second current flow rate, and provides the pinch valve with a first pinch valve control signal for controlling the pinch valve to be positioned at the second position.

16. The method for operating the flow rate control device of claim 15, the method further comprising, in response to the position of the pinch valve reaching the second position, generating a third target flow rate and a third current flow rate to be provided to the valve controller,
wherein the valve controller provides a second pinch valve control signal to the pinch valve based on the third target flow rate and the third current flow rate, and
the second pinch valve control signal controls the pinch valve to be positioned at the first position.

17. The method for operating the flow rate control device of claim 13, wherein:
the flow controller further includes an on-off valve that cuts off a supply of the fluid to be provided to the chamber, and
the modulating of the target flow rate and the current flow rate includes:
receiving a first target flow rate from the chamber and modulating the first target flow rate to generate a second target flow rate, and
receiving a first current flow rate from the flow controller and modulating the first current flow rate to generate a second current flow rate,
the second target flow rate is greater than the first target flow rate,
a first position of the pinch valve causes a convergent flow rate of the fluid provided to the chamber to be the first target flow rate, and
a second position of the pinch valve which causes the convergent flow rate of the fluid provided to the chamber to be the second target flow rate,
the motor control signal includes an on-off valve control signal for controlling the on-off valve, and
the on-off valve control signal controls the on-off valve to open in a first open section that provides the first target flow rate to the chamber,
the on-off valve control signal controls the on-off valve to open in a second open section that provides a fourth target flow rate different from the first target flow rate to the chamber, and
the on-off valve control signal controls the on-off valve to be closed in a first closed section between the first open section and the second open section.

18. The method for operating the flow rate control device of claim 17, further comprising, in the second open section:
receiving the fourth target flow rate from the chamber and modulating the fourth target flow rate to generate a fifth target flow rate;
receiving a fourth current flow rate from the flow controller and modulating the fourth current flow rate to generate a fifth current flow rate; and
providing the fifth target flow rate and the fifth current flow rate to the flow controller,
wherein:
a magnitude of the fourth target flow rate is smaller than a magnitude of the first target flow rate,
the motor control signal includes a pinch valve control signal for controlling the pinch valve,
the fifth target flow rate is smaller than the fourth target flow rate,
a fourth position of the pinch valve causes the convergent flow rate of the fluid provided to the chamber to be the fourth target flow rate,
a fifth position of the pinch valve causes the convergent flow rate of the fluid provided to the chamber to be the fifth target flow rate,
the valve controller provides the pinch valve with a third pinch valve control signal based on the fifth target flow rate and the fifth current flow rate for controlling the pinch valve to be positioned at the fifth position, and
a ratio of the second position to the first position is equal to a ratio of the fourth position to the fifth position.

19. The method for operating the flow rate control device of claim 18, further comprising:
generating a sixth target flow rate and a sixth current flow rate that are provided to the valve controller, in response to the position of the pinch valve reaching the fifth position,
wherein:
the valve controller provides a fourth pinch valve control signal to the pinch valve based on the sixth target flow rate and the sixth current flow rate, and
the fourth pinch valve control signal controls the pinch valve to be positioned at the fourth position.

20. A flow rate control device comprising:
a flow meter which measures a flow rate of a fluid flowing through a flow tube that provides the fluid to a chamber for processing a substrate;
a pinch valve which adjusts the flow rate of the fluid provided to the chamber; and
a flow modulation module which
receives a target flow rate of the fluid used for processing the substrate, from the chamber,
receives, from the flow meter, a current flow rate of the fluid provided to the chamber, and
generates a pinch valve control signal for controlling a position of the pinch valve such that the fluid is provided to the chamber at the target flow rate within a target reaction time,
wherein the flow modulation module:
is provided with a first target flow rate smaller than a second target flow rate from the chamber,
provides the pinch valve with a first pinch valve control signal for controlling the pinch valve to be positioned at a first position, and
provides the pinch valve with a second pinch valve control signal for controlling the pinch valve to be positioned at a second position, in response to the position of the pinch valve reaching the first position,
wherein the first position of the pinch valve causes a convergent flow rate of the fluid provided to the chamber to be the second target flow rate, and
wherein the second position of the pinch valve causes the convergent flow rate of the fluid provided to the chamber to be the first target flow rate.
